(19) United States
(12) Patent Application Publication
(10) Pub. No.: US 2026/0081433 A1
(43) Pub. Date: Mar. 19, 2026

(54) ENERGY HARVESTING MODULE

(71) Applicant: Eaton Intelligent Power Limited, Dublin (IE)

(72) Inventors: Dhanashri Jamadade, Kolhapur (IN); Prashant Zatale, Pune (IN); James Allen Wenzel, Sullivan, WI (US); Jyotsna Joshi, Jodhpur (IN); Lokesh Kumar, Aligarh (IN); Shrihari Shinde, Parbhani (IN); Aishwarya Milind Joshi, Pune (IN); Paresh Joshi, Pune (IN)

(21) Appl. No.: 19/323,090

(22) Filed: Sep. 9, 2025

(30) Foreign Application Priority Data
Sep. 16, 2024 (IN) 202411069809

(51) Int. Cl. H02J 7/34; H01H 33/28; H02J 3/00; H02J 7/00

(52) U.S. Cl. CPC H02J 7/345; H01H 33/28; H02J 3/001; H02J 7/855; H02J 2207/50

(57) ABSTRACT

A system includes: a current interrupting module including: a first housing and a switching device in the first housing, the switching device configured to control an electrical connection between a first node of an electrical system and a second node of an electrical system in response to a control signal; and an energy harvesting module including: a control apparatus configured to output the control signal; an energy harvesting apparatus electrically connected to the control apparatus; and a second housing that at least partially encloses the energy harvesting apparatus and the control apparatus. The energy harvesting apparatus is electrically connected to the first node regardless of a state of the switching device.

### CROSS-REFERENCE TO RELATED APPLICATION

This application claims priority to Indian Patent Application No. 202411069809, filed Sep. 16, 2024 and titled ENERGY HARVESTING MODULE, which is incorporated herein by reference in its entirety.

### TECHNICAL FIELD

This disclosure relates to an energy harvesting module.

### BACKGROUND

An electrical assembly (for example, a switch or fuse) may be mounted to a utility structure (such as, for example, a utility pole) or cutout.

### SUMMARY

In one aspect, a system includes: a current interrupting module including: a first housing and a switching device in the first housing, the switching device configured to control an electrical connection between a first node of an electrical system and a second node of an electrical system in response to a control signal; and an energy harvesting module including: a control apparatus configured to output the control signal; an energy harvesting apparatus electrically connected to the control apparatus; and a second housing that at least partially encloses the energy harvesting apparatus and the control apparatus. The energy harvesting apparatus is electrically connected to the first node regardless of a state of the switching device.

Implementations may include one or more of the following features.

The system also may include a connection system configured to releasably attach the current interrupting module to the energy harvesting module. The current interrupting module may detach from the connection system to provide a visible break during a fault condition, and, in these implementations, the energy harvesting apparatus is electrically connected to the first node while the visible break is provided.

The switching device may have an opened state and a closed state; and the energy harvesting apparatus is electrically connected to the first node when the switching device is in the opened state and when the switching device is in the closed state. The energy harvesting apparatus may include one or more of a voltage harvesting apparatus and a current harvesting apparatus. The current harvesting apparatus may be configured to sense rated load current that flows while the switching device is in the closed state and to power the control apparatus based on the sensed rated load current. The voltage harvesting apparatus may include a capacitive network configured to store leakage current while the switching device is in the opened state.

The system also may include an electrically insulating bracket configured to mount the energy harvesting apparatus to a utility structure.

The system also may include a mounting brace configured to surround the second housing and mount the energy harvesting apparatus to a utility structure.

The switching device may be a vacuum interrupter.

The energy harvesting apparatus may include a first capacitive network and a second capacitive configured to store leakage current from the first capacitive network and power the control apparatus while the switching device does not conduct current.

In another aspect, an energy harvesting module includes: a housing; a mounting system configured to attach the housing to a utility system structure; an input electrical terminal accessible from an exterior of the housing, the input electrical terminal configured to electrically connect to a source of electricity; and an energy harvesting apparatus including: a first capacitive network electrically connected to the input electrical terminal; a second capacitive network configured to receive leakage current from the first capacitive network and to store the leakage current as stored energy; and an energy harvest output configured to provide an electrical signal based on the stored energy. The energy harvesting module also includes an output electrical terminal electrically connected to the second capacitive network. The output electrical terminal is configured to electrically connect to electrical equipment external to the energy harvesting module and to provide the electrical signal to the electrical equipment.

Implementations may include one or more of the following features.

The electrical signal may include a voltage signal configured to provide power to the electrical equipment.

The energy harvesting module also may include an electronic control apparatus electrically connected to the second capacitive network, and the electronic control apparatus may be powered by the stored energy and generates a control signal based on the stored energy, and the control signal is the electrical signal provided to the electrical equipment.

The first capacitive network may include a capacitor with potting material.

The mounting system may include a mounting arm configured to attach the housing to the utility system structure.

The mounting system may be configured to attach the housing to a cutout.

The electrical signal may include one or more of: electrical power configured to drive a control of the electrical equipment, electrical power configured to drive a sensor module of the electrical equipment, and electrical power to drive a communication gateway of the electrical equipment.

Implementations of any of the techniques described herein may include a system, a mounting assembly, a kit for retrofitting an existing switching device, and/or a method. The details of one or more implementations are set forth in the accompanying drawings and the description below. Other features will be apparent from the description and drawings, and from the claims.

### DRAWING DESCRIPTION

FIG. 1 is a block diagram of a system that includes an energy harvesting module and a current interrupting module that is distinct from the energy harvesting module.

FIGS. 2A and 2B relate to another system that includes the current interrupting module of FIG. 1 and an energy harvesting module that is distinct from the current interrupting module.

FIG. 3 is a cross-sectional view of a current interrupting module.

FIG. 4A is a block diagram of another system that includes a current interrupting module and an energy harvesting module that is distinct from the current interrupting module.

FIG. 4B is a schematic of the system of FIG. 4A when the current interrupting module is closed.

FIG. 4C is a schematic of the system of FIG. 4A when the current interrupting module is open.

FIG. 4D is a block diagram of the system of FIG. 4A during a fault condition.

FIG. 4E is a schematic of an energy harvesting circuit.

FIG. 5 is a block diagram of an energy harvesting module.

FIG. 6 is a perspective exterior view of a system that includes an energy harvesting module and a holding part.

FIG. 7 is a perspective exterior view of a system that includes the energy harvesting module mounted to a cutout.

FIGS. 8A and 8B are perspective cross-sectional views of another system that includes an energy harvesting apparatus and a current interrupting module that is distinct from the energy harvesting apparatus.

### DETAILED DESCRIPTION

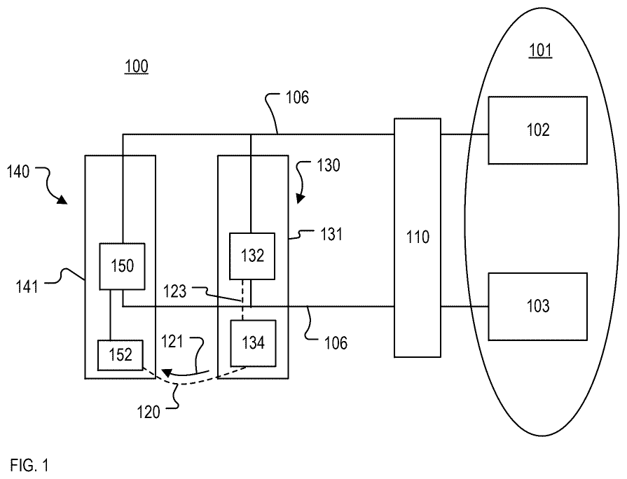

FIG. 1 is a block diagram of a system 100 that includes an energy harvesting module 130 and a current interrupting module 140 that is separate from the energy harvesting module 130. As discussed below, the energy harvesting module 130 offers uninterrupted or continuous energy harvesting and reliably powers a control apparatus 134 regardless of the state of the current interrupting module 140.

The current interrupting module 140 includes a switching device 150, which is any type of device that has an opened state and a closed state. In the opened state, the switching device 150 prevents the flow of electrical current through a power path 106. In the closed state, the switching device allows the flow of electrical current through the power path 106. The power path 106 is an electrically conductive connection between a first node 102 and a second node 103. For example, the first node 102 may be a source of electricity and the second node 103 may be a load, or vice versa. The power path 106 may include, for example, electrical cables, bus bars or other sturdy electrically conductive elements, electrically conductive contacts, electrically conductive terminals, and/or wires. The first node 102 and the second node 103 are any points in an electrical power system 101. The electrical power system 101 may be, for example, an electrical grid, an electrical system, or a multi-phase electrical network that provides electricity to commercial, industrial, municipal, and/or residential customers. The electrical power system 101 may be a medium-voltage electrical power system. In some implementations, the electrical power system has an operating voltage of, for example, at least 1 kilovolt (kV), up to 34.5 kV, up to 38 kV, or greater than 38 kV. The electrical power system 101 is an alternating current (AC) electrical network and may operate at a fundamental frequency of, for example, 50 or 60 Hertz (Hz).

The switching device 150 may be, for example, a switch that is capable of opening and closing repeatedly, such as a vacuum interrupter. The switching device 150 has a voltage and current rating that is appropriate for the application. For example, the switching device 150 may be rated for use in medium-voltage systems. Voltage ratings in the medium-voltage range include, for example, voltages between 15 kV and 38 kV. The switching device 150 may be rated for continuous current of, for example, between 5 amperes (A) to 800 A, between 100 A and 600 A, or between 100 and 200 A. The switching device 150 may be capable of interrupting fault currents of, for example, 1 kA to 10 kA, 1 kA to 4 kA, 1 kA to 7 kA, or up to 10 kA. These voltage and current ratings are provided as examples, and the switching device 150 may be configured for other ratings.

The current interrupting module 140 includes a driving apparatus 152 that opens or closes the switching device 150 in response to a control signal 121. The driving apparatus 152 may include, for example, an actuator coupled to a moving contact of the switching device 150. The current interrupting module 140 also includes a housing or body 141 that at least partially encloses the switching device 150 and the driving apparatus 152.

The energy harvesting module 130 includes an energy harvesting apparatus 132, a control apparatus 134 that generates the control signal 121 for the driving apparatus 152, and a housing 131 that at least partially encloses the energy harvesting apparatus 132 and the control apparatus 134. The housing 131 is separate from the housing 141. The energy harvesting apparatus 132 is any component or collection of components capable of harvesting electrical energy. For example, the energy harvesting apparatus 132 may include a capacitor, a network of capacitive devices, and/or resistive-capacitive network. The energy harvesting apparatus 132 powers the control apparatus 134. The control apparatus 134 may be, for example, an electronic control system that includes an electronic processor, an electronic memory, and a communications interface. The control apparatus 134 may be a microcontroller.

The control apparatus 134 has a much lower current and voltage rating than the switching device 150. For example, the control apparatus 134 may operate at voltages of 5V or 12V. The control apparatus 134 receives power from the energy harvesting apparatus 132 through a low-power connection 123 (shown with a dashed line style). The control apparatus 134 is also electrically connected to the driving apparatus 152 via a low-power connection 120 (shown with a dashed line style).

The energy harvesting module 130 is mounted to a structure 110. The structure 110 may be a structure intended for mounting overhead powerlines, such as, for example, a utility pole, pylon, or frame. The structure 110 may be an insulating bracket (such as a cutout) that is mounted to a utility pole or other sturdy object. In some implementations, the structure 110 is part of an underground distribution system. For example, the structure 110 may be one or more bushings in a cabinet or vault.

Under ordinary operating conditions, the current interrupting module 140 is mounted to the energy harvesting module 130, and the current interrupting module 140 is in parallel with the energy harvesting module 130. When the switching device 150 is in the closed state, rated current (for example, 5 A to 600 A) flows in the power path 106 and through the switching device 150. The energy harvesting module 130 has a much higher impedance than the closed switching device 150 such that almost all of the current flows in the power path 106 from the node 102 to the node 103 through the closed switching device 150. For example, the energy harvesting module 130 may have an insulation resistance of about 2×10⁵ megaOhm (MΩ) or greater. The energy harvesting module 130 may include a current transformer that senses current in the power path 106 and powers the control apparatus 134 with the sensed current. When the switching device 150 is in the opened state, rated current does not flow in the power path 106 or through the switching device 150. However, the energy harvesting apparatus 132 remains electrically connected to the node 102 and a leakage current (which may be on the order of milliamps (mA)) flows into a capacitive network of the energy harvesting module 130. The energy stored in the capacitive network powers the control apparatus 134. Thus, the control apparatus 134 is powered by the energy harvesting apparatus 132 regardless of whether the switching apparatus is in the closed state or the opened state.

Furthermore, the energy harvesting apparatus 132 harvests energy and powers the control apparatus 134 during fault conditions and while a visible break is displayed. Under fault conditions, the current interrupting module 140 disconnects the node 102 from the node 103 by opening the switching device 150 and/or detaching from the energy harvesting module 130. The energy harvesting module 130 remains connected to the node 102. The high impedance of the energy harvesting module 130 maintains the electrical disconnection between the nodes 102 and 103 while allowing the leakage current to flow into the energy harvesting apparatus 132. In this way, the energy harvesting apparatus 132 continues to harvest energy during a fault condition and while a visible break is displayed.

Although some prior current interrupting systems include energy harvesting mechanisms, these prior systems do not continue to harvest energy under fault conditions. For example, some prior overhead cutout mounted reclosers include an energy harvesting system enclosed in a housing with a vacuum interrupter that harvests energy while it flows in the vacuum interrupter. The housing is mounted overhead in an electrically insulating bracket (or cutout) and drops out of the cutout in response to a fault condition. Although this visible indication (or visible break) provides visual notice that the recloser has opened the power path, the energy harvesting mechanism is unable to harvest energy because the power path is opened. Moreover, although the energy harvesting mechanism of these prior systems may be capable of storing some energy that was harvested prior to the fault condition, this prior-harvested energy typically dissipates before resolution of the fault, leaving no energy available to control the recloser at start-up. Thus, the recloser is unable to immediately reestablish current flow in the power path after the fault is cleared.

On the other hand, the energy harvesting apparatus 132 remains electrically connected to the node 102 even when the switching device 150 is open and even when the current interrupting module 140 is detached from the energy harvesting module 130 in a visible break. In this way, when the system 100 is re-started, power is available for the control apparatus 134 and the control apparatus 134 can immediately provide the control signal 121 to the driving apparatus 152 to close the switching device 150 and re-establish the electrical connection between the nodes 102 and 103. Thus, the system 100 avoids delays that could otherwise arise if power was not available for the control apparatus 134. Furthermore, as compared to a current interrupting module that includes an energy harvesting mechanism and a current interrupting mechanism in the same housing, the current interrupting module 140 includes fewer parts and may be lighter, easier to manufacture and repair, and less expensive.

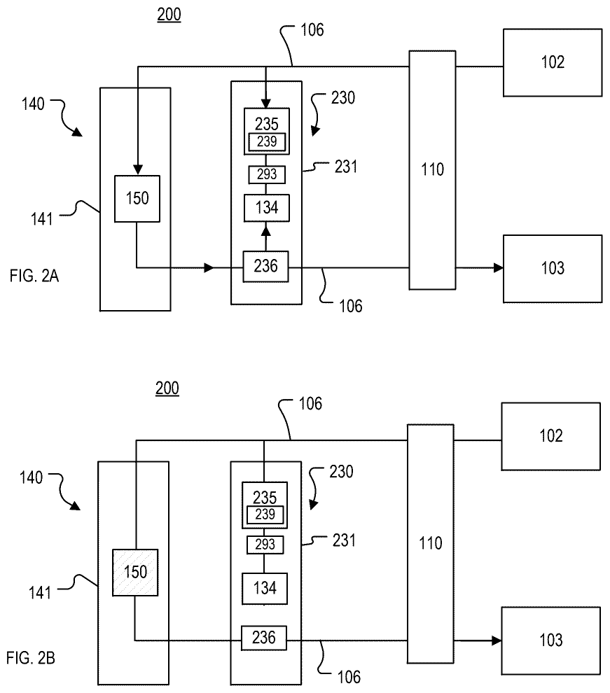

FIGS. 2A and 2B relate to a system 200 that includes the current interrupting module 140 and an energy harvesting module 230. The energy harvesting module 230 is mounted to the structure 110, and the current interrupting module 140 is mounted to the energy harvesting module 230. The energy harvesting module 230 includes a voltage harvesting module 235, the control apparatus 134, and a current harvesting module 236. The voltage harvesting module 235 and the current harvesting module 236 are electrically connected to the control apparatus 134. The voltage harvesting module 235 includes one or more high-voltage or medium-voltage capacitive devices 239. The capacitive device 239 may be a medium-voltage capacitor that includes a potting material around the capacitive element. The current harvesting module 236 includes a current transformer (CT).

FIG. 2A shows current flow when the switching device 150 is closed. FIG. 2B shows current flow when the switching device 150 is open. The switching device 150 is shaded with diagonal lines in FIG. 2B to indicate that the switching device 150 is open. When the switching device 150 is closed (FIG. 2A), the voltage harvesting module 235, the control apparatus 134, and the current harvesting module 236 form a high-impedance path in parallel with the closed switching device 150. The rated current flows in the power path 106 from the node 102 to the node 103 through the switching device 150. The CT of the current harvesting module 236 senses the rated current in the power path 106 and produces an output current that is provided to the control apparatus 134. In this way, the CT harvests energy from the power path 106 when the switching device 150 is closed.

FIG. 2B shows current flow when the switching device 150 is open. The switching device 150 is open in a fault condition and may be open under other conditions. For example, the switching device 150 may be intentionally opened for planned maintenance of the nodes 102, 103; the energy harvesting module 230; and/or the current interruption module 140. When the switching device 150 is open, current does not flow through the switching device 150 and the rated current does not flow from the node 102 to the node 103. The voltage harvesting module 235 remains electrically connected to the source 102. A leakage current flows through the capacitive device 239 and charges a low-voltage capacitive network 293. The energy stored in the low-voltage capacitive network 293 powers the control apparatus 134. Rated current does not flow between the switching device 150 and the node 103, and the CT of the current harvesting module 236 does not harvest energy from the power path 106.

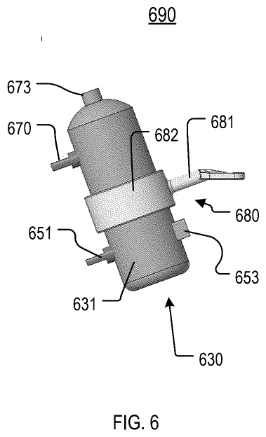

Thus, energy is harvested and the control apparatus 134 is powered when the switching device 150 is closed and when the switching device 150 is open. The energy harvesting module 230 may be implemented in other ways. For example, the energy harvesting module 230 may be implemented without the current harvesting module 236. In these implementations, the control apparatus 134 is powered by energy stored in the capacitor(s) of the voltage harvesting module 235. In another example, the energy harvesting module 230 may be implemented as a stand-alone device, such as shown in FIG. 5.

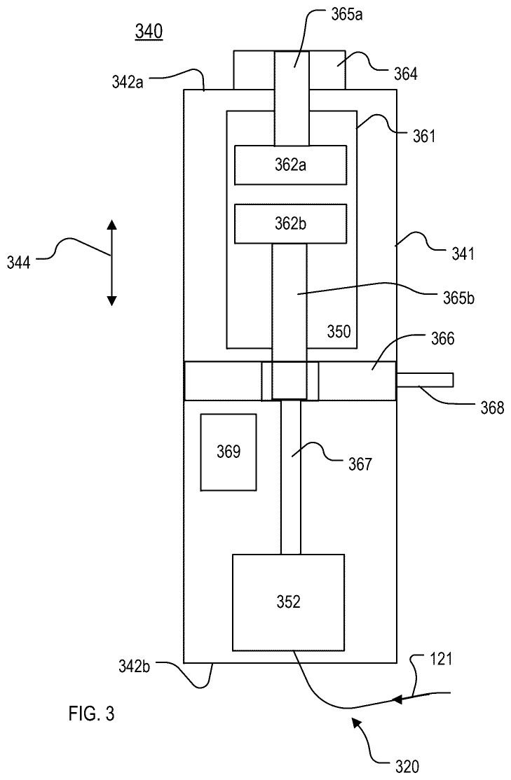

FIG. 3 is a cross-sectional view of a current interrupting module 340. The current interrupting module 340 is an example of an implementation of the current interrupting module 140 (FIGS. 1, 2A, and 2B).

The current interrupting module 340 includes a connection interface 364 that is configured to electrically and mechanically connect the current interrupting module 340 to an energy harvesting module, such as the energy harvesting module 130 or 230. The current interrupting module 340 also includes a vacuum interrupter 350 that is enclosed within a housing 341. The vacuum interrupter 350 includes a stationary contact 362a and a moveable contact 362b enclosed in a vacuum bottle 361. The stationary contact 362a is at an end of a stationary rod 365a, and the moveable contact 362b is at an end of a moveable rod 365b. The stationary rod 365a is electrically connected to the connection interface 364. The stationary contact 362a, the stationary rod 365a, the moveable contact 362b, and the moveable rod 365b are made of an electrically conductive material, such as, for example, a metal or a metal alloy. Examples of materials that may be used as the stationary contact 362a, the stationary rod 365a, the moveable contact 362b, and the moveable rod 365b include, without limitation, tin, steel, brass, gold, copper, silver, and combinations of such materials.

The current interrupting module 340 also includes a driving apparatus 352 that controls the state of the vacuum interrupter 350. The driving apparatus 352 is any type of device that is capable of moving the moveable rod 365b along a path 344. For example, the driving apparatus 352 may be an actuator. In implementations in which the driving apparatus 352 is an actuator, the actuator may be, for example, an electromagnetic actuator or a mechanical actuator.

The driving apparatus 352 is electrically connected to a low-power connection 320 that carries a control signal from an external control system (such as the control signal 121 from the control apparatus 134). The control signal includes information that controls the driving apparatus 352. For example, the control signal may include a command that causes the driving apparatus 352 to close the vacuum interrupter 350. The driving apparatus 352 is mechanically coupled to the moveable rod 365b via an operating rod 367. In the example of FIG. 3, the stationary contact 362a and the moveable contact 362b are separated and vacuum interrupter 350 is in an open state in which current cannot pass through the vacuum interrupter 350. To change the state of the vacuum interrupter 350, the driving apparatus 352 moves the operating rod 367 and the moveable rod 365b toward the stationary contact 362a until the moveable contact 362b is joined to the stationary contact 362a.

The current interrupting module 340 also includes a sensor system 369. The sensor system 369 may include, for example, a current transformer (CT) or other type of current sensor and/or a voltage sensor. The sensor system 369 also may include auxiliary items such as driving circuitry and interfaces to provide or receive signals. The sensor system 369 is used to monitor the current flowing in the current interrupting module 340. The sensor system 369 may be coupled to the driving apparatus 352. In some implementations, the sensor system 369 is configured to declare a fault condition in response to sensing a current and/or voltage having a magnitude that exceeds a threshold, and the driving apparatus 352 is configured to open the vacuum interrupter 350 in response to the sensor system 369 declaring a fault condition. In these implementations, the vacuum interrupter 350 may open regardless of whether or not the control signal 121 is provided to the driving apparatus 352.

The current interrupting module 340 also includes a current exchange 366 that is electrically connected to the moveable rod 365b and a terminal 368. The terminal 368 is accessible from an exterior of the current interrupting module 340 and is configured to be electrically connected to an external device or an electrical cable. The current exchange 366 and the terminal 368 are made from electrically conductive materials, such as, for example, metal or a metal alloy. For example, the current exchange 366 and the terminal 368 may be made of copper, gold, silver, and/or brass. The current exchange 366 and the moveable rod 365b are physically coupled to each other in any suitable manner that allows the moveable rod 365b to move while maintaining the electrical connection. For example, the moveable rod 365b and the current exchange 366 may be connected with a braided and/or laminated flexible metallic bar.

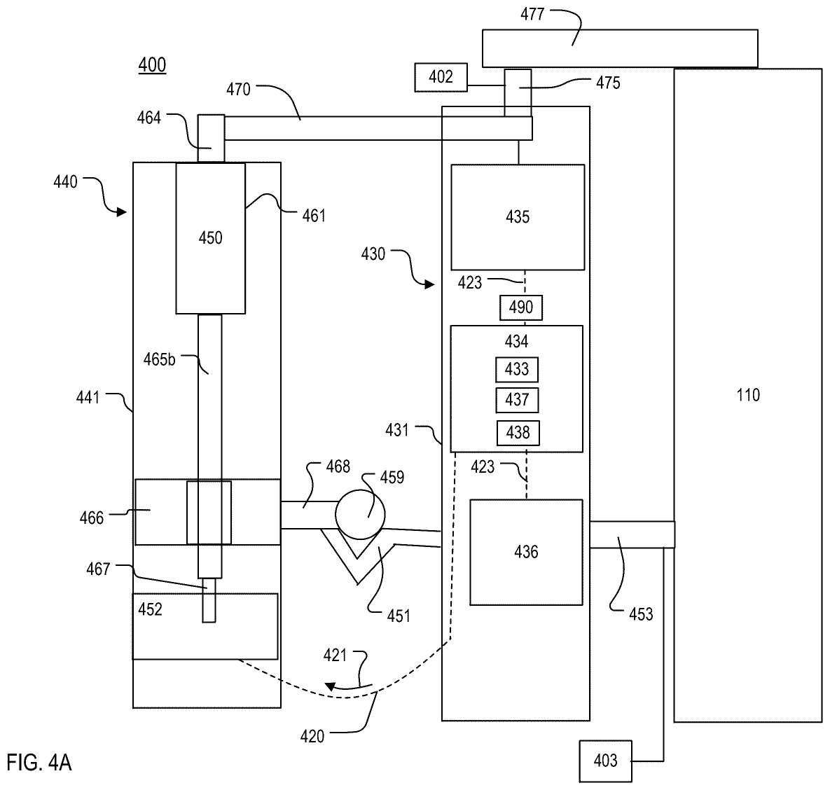

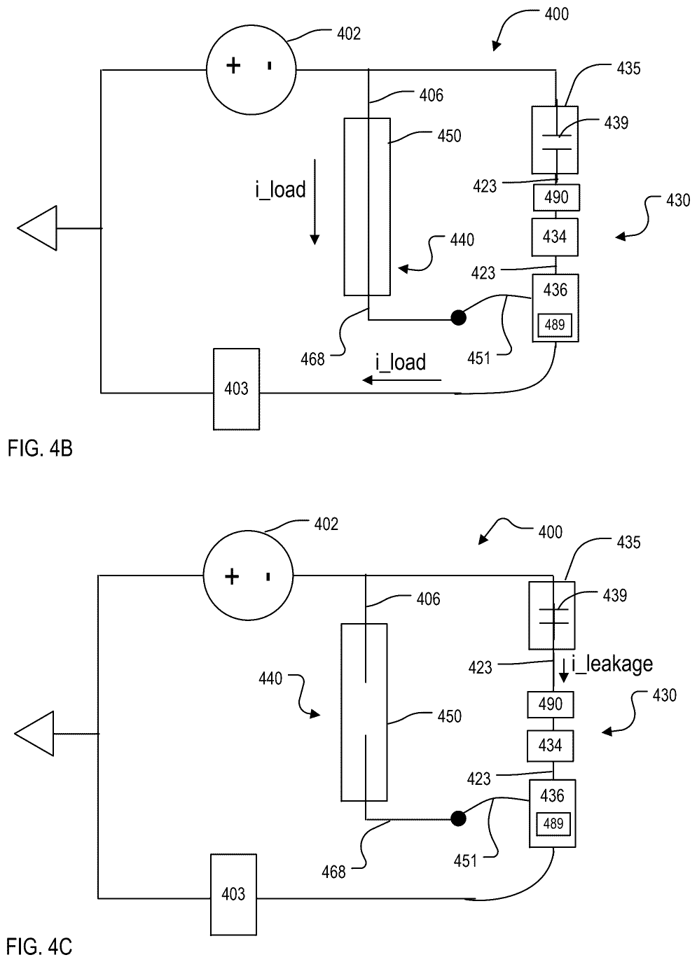

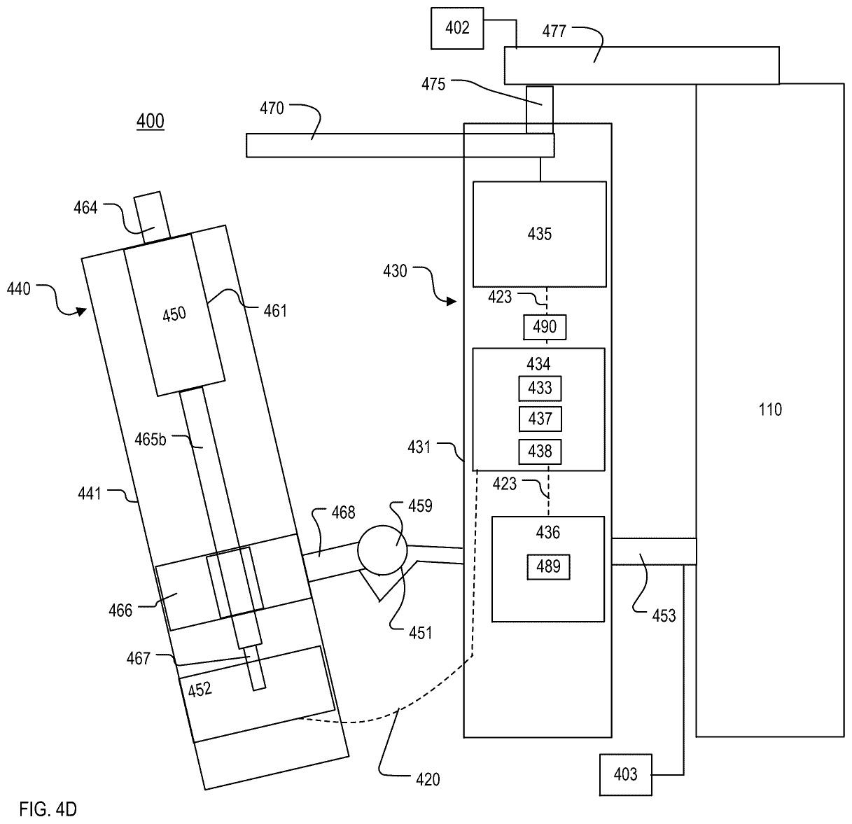

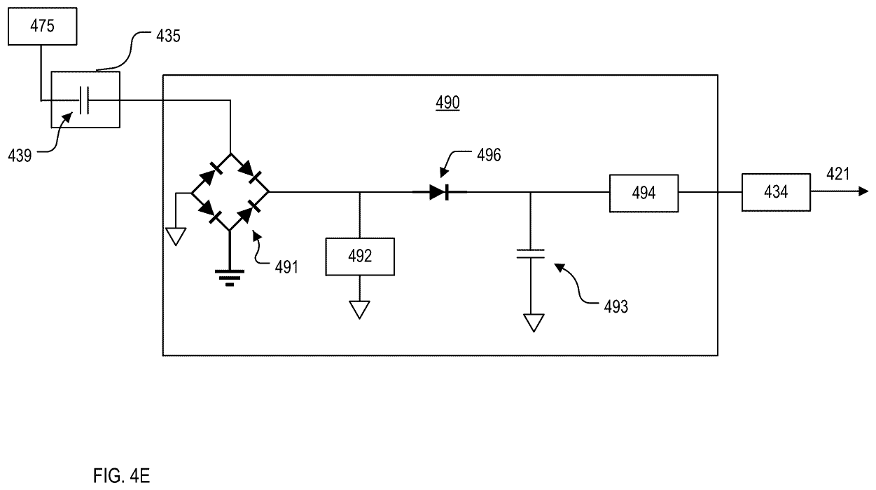

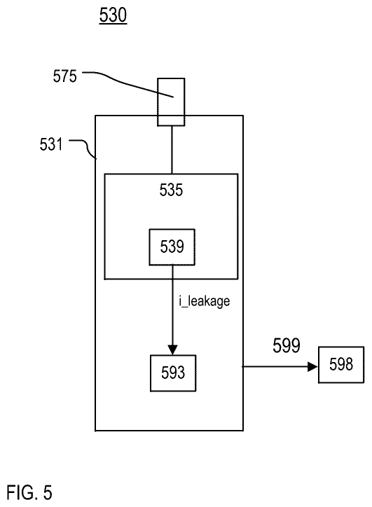

FIG. 4A is a block diagram of a system 400 that includes a current interrupting module 440 and an energy harvesting module 430. The energy harvesting module 430 is mounted to the structure 110 by a first mounting assembly 447 and a second mounting assembly 453. The first mounting assembly 447 is attached to an upper part of the structure 110 and the second mounting assembly 453 is attached to a part of the structure 110 that is below the upper part. The current interrupting module 440 is attached to the energy harvesting module 430 with a separable mounting assembly that includes an upper attachment mechanism 470 and a lower attachment mechanism 451.

The current interrupting module 440 includes a vacuum interrupter 450 that is similar to the vacuum interrupter 350. The vacuum interrupter 450 includes a vacuum bottle 461 that encloses stationary and moveable contacts (not shown), a moveable rod 465b that is electrically connected to the moveable contact and to a current exchange 466, and an actuator 452. The actuator 452 is coupled to the moveable rod 465b via an operating rod 467. The actuator 452 moves the operating rod 467 toward the stationary contact to join the stationary and moveable contacts to close the vacuum interrupter 450 and moves the operating rod 467 away from the stationary contact to separate the stationary and moveable contacts to open the vacuum interrupter 450. FIG. 4B is a schematic of the system 400 when the vacuum interrupter 450 is closed. FIG. 4C is a schematic of the system 400 when the vacuum interrupter 450 is opened.

Referring again to FIG. 4A, the energy harvesting module 430 includes a voltage harvesting apparatus 435, a control apparatus 434, and a current harvesting apparatus 436. The current harvesting apparatus 436 includes a current transformer 489. The voltage harvesting apparatus 435 includes a capacitive network 439 (FIGS. 4B and 4C). Referring also to FIG. 4E, an energy harvesting circuit 490 is electrically connected to the capacitive network 439 and to the control apparatus 434. The voltage harvesting apparatus 435 provides power to the control apparatus 434 via the energy harvesting circuit 490. The energy harvesting circuit 490 includes a diode network 491, a switching circuit 492, a diode 496, a low-voltage capacitive network 493, and a DC-DC buck converter 494. The output of the DC-DC buck converter powers the control apparatus 434.

The control apparatus 434 is an electronic control that includes an electronic processing module 433, an electronic storage 437, and an input/output (I/O) interface 438. The electronic processing module 433 includes one or more electronic processors. The electronic processors of the module 433 may be any type of electronic processor and may or may not include a general purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 437 may be any type of electronic memory that is capable of storing data, and the electronic storage 437 may include volatile and/or non-volatile components. The electronic storage 437 and the processing module 433 are coupled such that the processing module 433 may access or read data from the electronic storage 437 and may write data to the electronic storage 437. The electronic storage 437 also may store information and data related to the operation of the vacuum interrupter 450. For example, the electronic storage 437 may store instructions that, when executed by the processing module 433, cause the control apparatus 434 to issue a control signal 421 to open or close the vacuum interrupter 450.

The I/O interface 438 is any interface that allows a human operator and/or an autonomous process to interact with the control apparatus 434. The I/O interface 438 may include, for example, a display, audio input and/or output (such as speakers and/or a microphone), a serial or parallel port, a Universal Serial Bus (USB) connection, and/or any type of network interface, such as, for example, Ethernet. The I/O interface 438 also may allow communication without physical contact through, for example, an IEEE 802.11, Bluetooth, or a near-field communication (NFC) connection. The control apparatus 434 may be, for example, operated, configured, modified, or updated through the I/O interface 438.

The I/O interface 438 is also connected to the voltage harvesting apparatus 435 and the current harvesting apparatus 436 via low-power connections 423. The low-power connections 423 allow the voltage harvesting apparatus 435 and the current harvesting apparatus 436 to power the control apparatus 434. The I/O interface 438 is also connected to the actuator 452 via a low-power connection 420. The I/O interface 438 sends the control signal 421 to the actuator 452 to control the state of the vacuum interrupter 450. The I/O interface 438 also may allow the control apparatus 434 to communicate with systems external to and remote from the energy harvesting module 430. For example, the I/O interface 438 may include a communications interface that allows communication between the control apparatus 434 and a remote station using, for example, the Supervisory Control and Data Acquisition (SCADA) protocol or another services protocol. The remote station may be any type of station through which an operator is able to communicate with the control apparatus 434 without making physical contact with the control apparatus 434. For example, the remote station may be a computer-based work station, a smart phone, remote control, tablet, or a laptop computer.

During typical operation, the current interrupting module 440 is attached to the energy harvesting module 430, as shown in FIG. 4A. In the implementation shown, a terminal 475 is electrically connected to a source 402 and the second mounting assembly 453 is connected to a load 403. The source 402 is any type of electrical source. For example, the source 402 may be a medium-voltage source with a voltage of 1 kV to 38 kV. In some implementations, the source 402 is a single phase 25 kV AC voltage source. The load 403 is any device or apparatus that consumes, transfers, or absorbs electricity. For example, the load 403 may be a transformer.

Referring also to FIG. 4B, when the vacuum interrupter 450 is closed, load current (i_load) flows in a power path 406 between the source 402 and the load 403. The load current (i_load) is an AC current with a magnitude appropriate for the application. For example, the load current (i_load) may be 5 A to 600 A. The load current (i_load) flows into the terminal 475 and the upper attachment mechanism 470, into a connection interface 464 on the vacuum interrupter 450, through the closed vacuum interrupter 450, into the current exchange 466 and into a terminal 468, into the lower attachment mechanism 451, and into second mounting assembly 453. The energy harvesting module 430 is a high impedance capacitive path in parallel with the closed vacuum interrupter 450, which has a very low impedance. Thus, the operation of the load 403 is not affected by the presence of the energy harvesting module 430. The current transformer 489 of the current harvesting apparatus 436 senses current that flows in the power path 406 and provides electrical power to the control apparatus 434 through the low-power connection 423.

To open the vacuum interrupter 450, the control apparatus 434 provides the control signal 421 to the actuator 452, and the actuator 452 causes the vacuum interrupter 450 to open. Referring also to FIG. 4C, current does not flow through the open vacuum interrupter 450. However, the energy harvesting module 430 remains electrically connected to the source 402 and a leakage current (i_leakage) flows from the capacitive network 439 into the energy harvesting circuit 490. The leakage current (i_leakage) is converted into a DC current that charges the low-voltage capacitive network 493. The DC-DC buck converter 494 (FIG. 4E) converts the energy stored in the low-voltage capacitive network 493 to a DC voltage that is appropriate for the control apparatus 434 and the output of the DC-DC buck converter 494 powers the control apparatus 434. Thus, energy harvesting continues and the control apparatus 434 remains powered even when the vacuum interrupter 450 is open.

Referring also to FIG. 4D, during a fault condition, the connection interface 464 detaches or separates from the upper attachment mechanism 470 and rotates about a pivot point 459. The separation of the current interrupting module 440 from the upper attachment mechanism 470 disconnects the source 402 from the load 403 regardless of whether the vacuum interrupter 450 is open or closed and provides a visible break, which is a visual indication that the power path 406 is open. When the visible break is displayed, the leakage current (i_leakage) flows through the capacitive network 439 and charges the low-voltage capacitive network 493, and the energy stored in the low-voltage capacitive network 493 powers the control apparatus 434. Thus, the energy harvesting module 430 continues to collect energy and continues to power the control apparatus 434 while the visible break is displayed.

After the fault condition is cleared, the connection interface 464 of the current interrupting module 440 is re-attached to the upper attachment mechanism 470 with the vacuum interrupter 450 in the opened state. The control apparatus 434 is powered by the capacitive network 439 and can immediately provide the control signal 421 to the actuator 452 to close the vacuum interrupter 450. This allows the source 402 and the load 403 to be reconnected without unnecessary delay after the resolution of the fault.

FIG. 5 is a block diagram of an energy harvesting module 530. The energy harvesting module 530 is a stand-alone device that can power any auxiliary or external equipment 598. The equipment 598 may be, for example, a communications device or gateway, a switchgear (overhead or underground), or a recloser. The energy harvesting module 530 includes a voltage harvesting apparatus 535 with a high impedance capacitive network 539, an energy storage network 593, and a housing 531 that encloses the voltage harvesting apparatus 535 and the energy storage network 593. The capacitive network 539 is electrically connected to an electrically conductive terminal 575 that extends from the housing 531.

In operational use, the electrically conductive terminal 575 is electrically connected to a power source, such as the source 402. A leakage current (i_leakage) flows through the capacitive network 539 and is stored as a voltage potential in the energy storage network 593. The energy storage network 593 provides a power output 599 to the equipment 598. The power output 599 may be, for example, a 5V DC voltage signal.

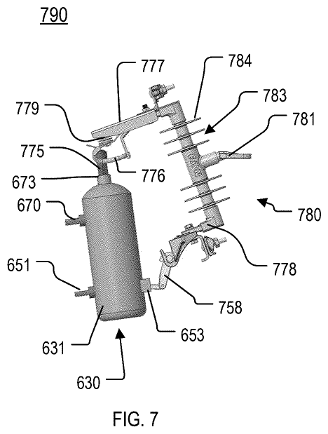

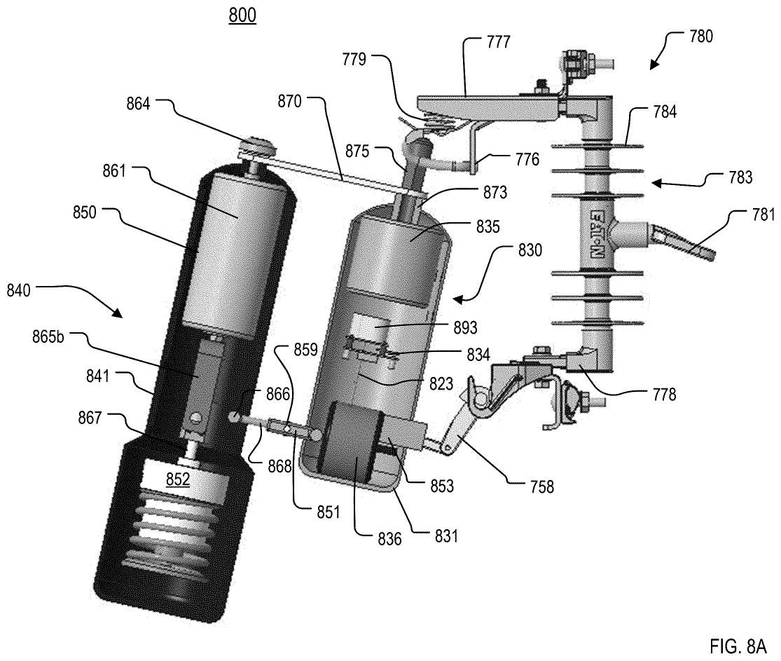

The energy harvesting module 530 may be attached to a structure that supports overhead wires, such as a utility pole, cross-arm, or frame, or the energy harvesting module 530 may be mounted to an electrically insulating cutout (such as the cutout 780 of FIG. 7). Furthermore, the energy harvesting module 530 may be mounted in a cabinet or vault that is part of an underground distribution system. In implementations in which the energy harvesting module 530 is attached to the structure that supports overhead wires, the housing 531 is attached to a mounting device (such as a holding part 680 shown in FIG. 6) that attaches to the structure.

Other implementations of the energy harvesting module 530 are possible. For example, the energy harvesting module 530 may be a stand-alone device configured to control the external equipment 598. In these implementations, the energy harvesting module 530 includes the control apparatus 434, the power output 599 powers the control apparatus 434 instead of being provided to the external equipment 598, and the control apparatus 434 provides a control signal to the external equipment. In this way, the energy harvesting module 530 controls the external equipment. In another example, the energy harvesting module 530 may include a current transformer in addition to the voltage harvesting apparatus 535.

FIG. 6 is a perspective exterior view of a system 690 that includes an energy harvesting module 630 and a holding part 680. The energy harvesting module 630 includes a housing 631 that encloses a voltage harvesting apparatus and a control apparatus. The energy harvesting module 630 may or may not include a current harvesting apparatus. In implementations in which the energy harvesting module 630 includes a current harvesting apparatus, the current harvesting apparatus is enclosed in the housing 631.

An upper connection mechanism 670 and a lower connection mechanism 651 extend radially outward from the housing 631. The upper connection mechanism 670 and the lower connection mechanism 651 are configured to attach a current interrupting module (such as the current interrupting module 440) to the energy harvesting module 630. The housing 631 also includes a terminal portion 673, which receives an electrical terminal (such as the terminal 475) and a mounting assembly 653, which is configured to electrically connect to a load (such as the load 403).

The holding part 680 includes a holding portion 682 that surrounds the housing 631 and a mounting arm 681 that extends from the holding portion 682. The mounting arm 681 is configured to be mounted to a utility pole or other structure.

The energy harvesting module 630 may be mounted to a utility pole or structure in other ways and the energy harvesting module 630 may be used without the holding part 680. For example, FIG. 7 is a perspective exterior view of a system 790 that includes the energy harvesting module 630 mounted to a cutout 780. In the example of FIG. 7, the cutout 780 has a substantially U shape or C shape. The cutout 780 is made of an electrically insulating material, such as, for example, a ceramic or an insulating polymer. The cutout 780 includes an upper portion 777 and a lower portion 778. A middle portion 783 extends between the upper portion 777 and the lower portion 778. Insulating sheds 784 extend outward from the middle portion 783. The middle portion 783, the upper portion 777, and the lower portion 778 are joined together or made from a single, continuous piece of insulating material such that the cutout 780 is a unitary piece (for example, ceramic with metal inserts or polymer overmolded on metal or fiberglass). The cutout 780 also includes a mounting mechanism 781 that extends from the middle portion 783. The mounting mechanism 781 is configured to attach the cutout 780 to a separate structure, such as a utility pole or a cross arm.

The energy harvesting module 630 includes an electrical terminal 775. The electrical terminal 775 is electrically connected to the voltage harvesting apparatus in the housing 631 and extends from the terminal portion 673 of the housing 631. The terminal 775 is also electrically connected to a source line 776 in the upper portion 777 of the cutout 780. The source line 776 is electrically connected to a source (such as the source 402). The cutout 780 also includes a spring 779 that helps maintain the electrical connection between the electrical terminal 775 and the source line 776. The mounting assembly 653 is electrically connected to a load connection 758 that is configured for electrical connection to a load (such as the load 403).

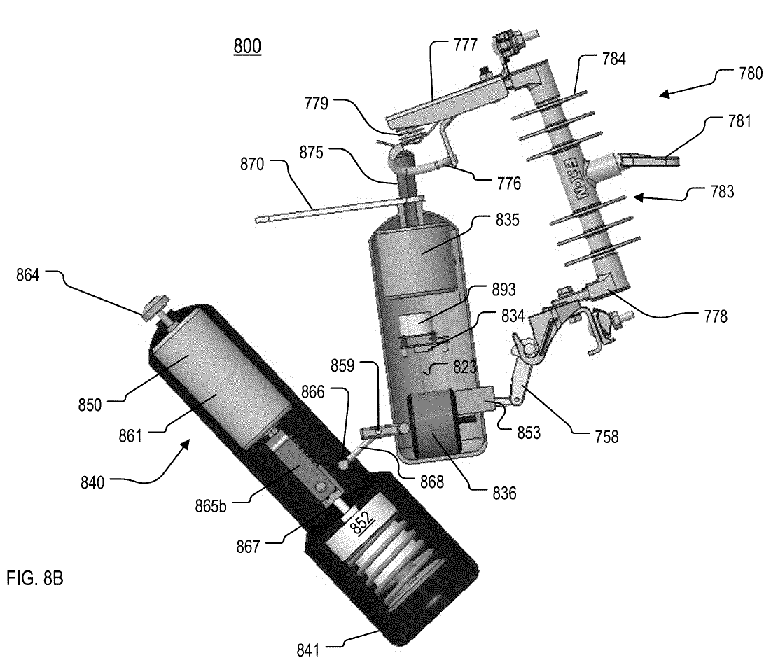

FIGS. 8A and 8B are perspective cross-sectional views of a system 800. The system 800 includes an energy harvesting module 830 mounted to the cutout 780 and a current interrupting module 840 releasably mounted to the energy harvesting module 830. Under typical operating conditions (FIG. 8A), the current interrupting module 840 is attached to the energy harvesting module 830. During a fault condition (FIG. 8B), the current interrupting module 840 detaches or separates from the energy harvesting module 830 to display a visible break.

The energy harvesting module 830 includes a voltage harvesting apparatus 835, a low-voltage capacitive network 893, a control apparatus 834, and a current harvesting apparatus 836. The voltage harvesting apparatus 835 includes a high-voltage or medium voltage capacitor and the current harvesting apparatus 836 is a current transformer (CT). The control apparatus 834 is an electronic control and may be similar to the control apparatus 434. Each of the low-voltage capacitive network 893 and the current harvesting apparatus 836 is electrically connected to the control apparatus 834 via a low-power connection 823 (only the connection 823 between the current harvesting apparatus 836 and the control apparatus 834 is labeled in FIGS. 8A and 8B).

The control apparatus 834, the voltage harvesting apparatus 835, the low-voltage capacitive network 893, and the current harvesting apparatus 836 are enclosed in a housing 831. The voltage harvesting apparatus 835 is electrically connected to an electrically conductive terminal 875 that extends through a terminal portion 876 at an end of the housing 831. The current harvesting apparatus 836 is electrically connected to a connection portion 851 and a mounting assembly 853. The connection portion 851 and the mounting assembly 853 extend through the housing 831 in different directions and are electrically conductive.

The current interrupting module 840 includes a vacuum interrupter 850 and an actuator 852 that controls the state of the vacuum interrupter 850. The vacuum interrupter 850 and the actuator 852 are enclosed in a housing 841. The vacuum interrupter 850 includes stationary and moveable contacts (not shown) enclosed in a vacuum bottle 861. The stationary contact of the vacuum interrupter 850 is electrically connected to a stationary rod (not shown) and an electrically conductive terminal 864 that is accessible from an exterior of the housing 841. The moveable contact of the vacuum interrupter 850 is electrically connected to a moveable rod 865b, which is mechanically coupled to an operating rod 867. The actuator 852 is coupled to the operating rod 867. The actuator 852 opens the vacuum interrupter 850 by moving the operating rod 867 away from the stationary contact to separate the moveable contact from the stationary contact and closes the vacuum interrupter 850 by moving the operating rod 867 toward the stationary contact to join the moveable contact to the stationary contact. The moveable rod 865b is electrically connected to a current exchange 866, which includes a terminal 868 that extends through the housing 841.

The terminal 868 is attached to the connection portion 851 at a pivot point 859. The electrically conductive terminal 864 (which is electrically connected to the stationary contact of the vacuum interrupter 850) is attached to one end of a separable electrically conductive mounting piece 870. The terminal 875 (which is electrically connected to the voltage harvesting apparatus 835) is attached to the other end of the separable electrically conductive mounting piece 870.

In operational use in the absence of a fault condition, the current interrupting module 840 is attached to the energy harvesting module 830, and the energy harvesting module 830 is mounted to the cutout 780, as shown in FIG. 8A. The source line 776 is electrically connected to a source (such as the source 402). The terminal 875 of the energy harvesting module 830 is electrically connected to the separable electrically conductive mounting piece 870 and to the voltage harvesting apparatus 835. When the vacuum interrupter 850 is closed, rated load current flows into the source line 776, the terminal 875, the separable electrically conductive mounting piece 870, the terminal 864, the vacuum interrupter 850, the current exchange 866, and into mounting assembly 853 to the load (such as the load 403). The current transformer 836 senses the rated load current and powers the control apparatus 834. The impedance of the energy harvesting module 830 is much greater than the impedance of the closed vacuum interrupter 850. Although a small amount of current may flow from the terminal 875 into the voltage harvesting apparatus 835, almost all of the current flows to the vacuum interrupter 850. When the vacuum interrupter 850 is open, the rated load current does not flow through the vacuum interrupter 850. The terminal 785 is electrically connected to the source and leakage current flows through the voltage harvesting apparatus 835 and is stored in the low-voltage capacitive network 893, which provides power to the control apparatus 834.

Referring to FIG. 8B, during a fault condition, the separable electrically conductive mounting piece 870 releases the terminal 864 and the current interrupting module 840 rotates about the pivot point 859 to provide a visual indication that the power path has been opened and rated load current is not flowing to the load. The voltage harvesting apparatus 835 remains electrically connected to the terminal 875 and the source line 776. Leakage current flows through the voltage harvesting apparatus 835 and is stored in the low-voltage capacitive network 893, which powers the control apparatus 834.

These and other implementations are within the scope of the claims.

What is claimed is:

1. A system comprising:
a current interrupting module comprising: a first housing and a switching device in the first housing, the switching device configured to control an electrical connection between a first node of an electrical system and a second node of an electrical system in response to a control signal; and
an energy harvesting module comprising: a control apparatus configured to output the control signal; an energy harvesting apparatus electrically connected to the control apparatus; and a second housing that at least partially encloses the energy harvesting apparatus and the control apparatus, wherein the energy harvesting apparatus is electrically connected to the first node regardless of a state of the switching device.

2. The system of claim 1, further comprising: a connection system configured to releasably attach the current interrupting module to the energy harvesting module.

3. The system of claim 2, wherein the current interrupting module detaches from the connection system to provide a visible break during a fault condition, and the energy harvesting apparatus is electrically connected to the first node while the visible break is provided.

4. The system of claim 1, wherein the switching device comprises an opened state and a closed state; and the energy harvesting apparatus is electrically connected to the first node when the switching device is in the opened state and when the switching device is in the closed state.

5. The system of claim 4, wherein the energy harvesting apparatus comprises one or more of a voltage harvesting apparatus and a current harvesting apparatus.

6. The system of claim 5, wherein the current harvesting apparatus is configured to sense rated load current that flows while the switching device is in the closed state and to power the control apparatus based on the sensed rated load current.

7. The system of claim 6, wherein the voltage harvesting apparatus comprises a capacitive network configured to store leakage current while the switching device is in the opened state.

8. The system of claim 2, further comprising an electrically insulating bracket configured to mount the energy harvesting apparatus to a utility structure.

9. The system of claim 2, further comprising a mounting brace configured to surround the second housing and mount the energy harvesting apparatus to a utility structure.

10. The system of claim 1, wherein the switching device is a vacuum interrupter.

11. The system of claim 1, wherein the energy harvesting apparatus comprises a first capacitive network and a second capacitive configured to store leakage current from the first capacitive network and power the control apparatus while the switching device does not conduct current.

12. An energy harvesting module comprising:
a housing;
a mounting system configured to attach the housing to a utility system structure;
an input electrical terminal accessible from an exterior of the housing, the input electrical terminal configured to electrically connect to a source of electricity;
an energy harvesting apparatus comprising:
a first capacitive network electrically connected to the input electrical terminal;
a second capacitive network configured to receive leakage current from the first capacitive network and to store the leakage current as stored energy; and
an energy harvest output configured to provide an electrical signal based on the stored energy; and
an output electrical terminal electrically connected to the second capacitive network, wherein the output electrical terminal is configured to electrically connect to electrical equipment external to the energy harvesting module and to provide the electrical signal to the electrical equipment.

13. The energy harvesting module of claim 12, wherein the electrical signal comprises a voltage signal configured to provide power to the electrical equipment.

14. The energy harvesting module of claim 12, further comprising an electronic control apparatus electrically connected to the second capacitive network, and wherein the electronic control apparatus is powered by the stored energy and generates a control signal based on the stored energy, and the control signal is the electrical signal provided to the electrical equipment.

15. The energy harvesting module of claim 12, wherein the first capacitive network comprises a capacitor with potting material.

16. The energy harvesting module of claim 12, wherein the mounting system comprises a mounting arm configured to attach the housing to the utility system structure.

17. The energy harvesting module of claim 12, wherein the mounting system is configured to attach the housing to a cutout.

18. The energy harvesting module of claim 12, wherein the electrical signal comprises one or more of: electrical power configured to drive a control of the electrical equipment, electrical power configured to drive a sensor module of the electrical equipment, and electrical power to drive a communication gateway of the electrical equipment.
